(19) United States
(12) Patent Application Publication
(10) Pub. No.: US 2025/0307008 A1
(43) Pub. Date: Oct. 2, 2025

(54) EXPLOITING DATA SPARSITY AT A MACHINE-LEARNING HARDWARE ACCELERATOR

(71) Applicant: Google LLC, Mountain View, CA (US)

(72) Inventors: Andrey Ayupov, Mountain View, CA (US); Suyog Gupta, Sunnyvale, CA (US)

(21) Appl. No.: 18/866,701

(22) PCT Filed: May 18, 2022
(86) PCT No.: PCT/US2022/029832

§ 371 Date: Nov. 18, 2024

(51) Int. Cl. G06F 9/50; G06N 3/04

(52) U.S. Cl. CPC G06F 9/5027; G06N 3/04

(57) ABSTRACT

Methods and systems, including computer-readable media, are described for exploiting data sparsity during computations for a neural network implemented on a hardware accelerator. Using a system controller, a set of compressed sparse parameters is derived from a parameter tensor and a mapping vector is generated based on the set of compressed sparse parameters. When the system(s) processes an opcode in an instruction indicating sparsity of the parameter tensor, an input vector is obtained from a first memory of the hardware accelerator and the compressed sparse parameters and the mapping vector are retrieved from a second memory of the hardware accelerator. The input vector is processed through a layer of the neural network using the mapping vector and the set of compressed sparse parameters.

### BACKGROUND

This specification generally relates to using hardware integrated circuits to perform group convolutions for a convolutional neural network.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

### SUMMARY

This document describes an improved integrated circuit architecture for a hardware accelerator and corresponding techniques for processing an input vector using a mapping vector and a set of compressed sparse parameters for a neural network layer. Each of the mapping vector and the set of compressed sparse parameters can be generated based on an operation code (“opcode”) that indicates a uniform sparsity format of multiple parameter tensors. The parameter tensors are associated with neural network layers of an artificial neural network, such as a CNN. The disclosed techniques can be used to accelerate tensor operations in support of neural network computations that involve processing the inputs of the input vector through one or more of the neural network layers.

One aspect of the subject matter described in this specification can be embodied in a computer-implemented method involving a neural network implemented on a hardware accelerator. The method includes deriving, from a parameter tensor, a set of compressed sparse parameters, generating a mapping vector based on the set of compressed sparse parameters, processing an instruction indicating a sparse computation to be performed using the compressed sparse parameters based on a sparsity of the parameter tensor; obtaining, based on the instruction, i) an input vector from a first memory of the hardware accelerator and ii) the compressed sparse parameters from a second memory of the hardware accelerator; and performing the sparse computation to process the input vector through a layer of the neural network using the mapping vector and the set of compressed sparse parameters.

These and other implementations can each optionally include one or more of the following features. For example, in some implementations, processing the input vector through the layer of the neural network includes: performing a dot product matrix multiplication operation between inputs of the input vector and corresponding weight values in the set of compressed sparse parameters.

In some implementations, the dot product matrix multiplication operation is performed at one or more multiplication cells of the hardware accelerator based on a respective bit value of each bit in the mapping vector. In some implementations, the method further includes: accessing hardware selection logic coupled to the first memory and to the second memory of the hardware accelerator; and selecting, using the hardware selection logic, a particular input of the input vector and a corresponding weight value in the set of compressed sparse parameters based on a respective bit value of a bit in the mapping vector.

Deriving the set of compressed sparse parameters can include generating a modified parameter tensor including only non-zero elements along a particular dimension of the parameter tensor. Generating the modified parameter tensor can include: for a particular column dimension of the parameter tensor: generating a compressed representation of the column dimension based on non-zero elements of the column dimension; and concatenating each non-zero element in the compressed representation of the column dimension.

In some implementations, generating the modified parameter tensor includes: preserving a respective dimensional position of each non-zero element in the parameter tensor prior to generating the modified parameter tensor. The parameter tensor can include multiple dimensions; and an opcode in the instruction indicates sparsity for a particular dimension of the multiple dimensions. The hardware accelerator is operable to process multi-dimensional parameter tensors; and an opcode in the instruction can indicate uniform sparsity across each of the multi-dimensional parameter tensors.

The first memory can be a scratchpad memory of the hardware accelerator and configured to store inputs and activations processed at the neural network layer. The second memory can include single instruction, multiple data (SIMD) registers and the method includes: storing the mapping vector at a first address of an SIMD register; and storing the set of compressed sparse parameters at a second, different address of the SIMD register.

Another aspect of the subject matter described in this specification can be embodied in a computer-implemented method performed using a hardware accelerator that implements a neural network comprising multiple neural network layers. The method includes receiving an instruction for a compute tile of the hardware accelerator.

The instruction is executable at the compute tile to cause performance of operations that include: identifying an opcode in the instruction that indicates sparsity of the parameter tensor; loading a set of compressed sparse parameters based on weight values derived from a parameter tensor that specifies weights for a layer of the neural network; and loading a mapping vector that is generated based on the set of compressed sparse parameters.

The operations include obtaining, based on the opcode, i) an input vector from a first memory of the hardware accelerator and ii) the set of compressed sparse parameters from a second memory of the hardware accelerator. The operations further include processing, based on the mapping vector, the input vector through the layer of the neural network using the set of compressed sparse parameters.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. Techniques are described for exploiting sparsity in data processed for machine-learning computations. Compressed sparse parameters that have only non-zero weight values are leveraged to realize certain hardware and computing efficiencies when processing an input image using, for example, a CNN machine-learning model implemented on computing devices such as tablets or smartphones.

The sparsity is exploited to realize computing efficiencies by generating compressed sparse parameters and corresponding mapping vectors when accelerating execution of artificial neural networks. The system detects upcoming sparsity patterns among datasets to be processed at a neural network layer and generates a set of compressed sparse parameters that include only non-zero values. The mapping vector maps discrete inputs of an input vector to the non-zero values of the compressed sparse parameters, which allows for streamlined processing of the dataset by leveraging a particular hardware architecture of special-purpose integrated circuits that accelerates execution of artificial neural networks.

Multiplication operations involving zero-value operands are generally regarded as wasted compute cycles. By using at least the compressed sparse parameters to process neural network inputs with only non-zero values, the machine-learning system can reduce its overall quantity of compute operations. This reduction is realized from removal of zero values from among the weight values of a parameter tensor being processed for a neural network layer. The reduced quantity of compute operations leads to corresponding reductions in power consumption and resource requirements (e.g., memory allocations and processor cycles).

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system for implementing a neural network machine-learning model.

FIG. 2 shows an example parameter tensor with K in N sparsity.

FIG. 3 shows a first example architecture for processing compressed sparse parameters.

FIG. 4 shows a second example architecture for processing compressed sparse parameters.

FIG. 5 shows an example processing pipeline for routing inputs obtained from a memory location to one or more compute cells.

FIG. 6 is an example process for exploiting data sparsity at a machine-learning hardware accelerator.

FIG. 7 illustrates an example of an input tensor, a parameter tensor, and an output tensor.

Like reference numbers and designations in the various drawings indicate like elements.

### DETAILED DESCRIPTION

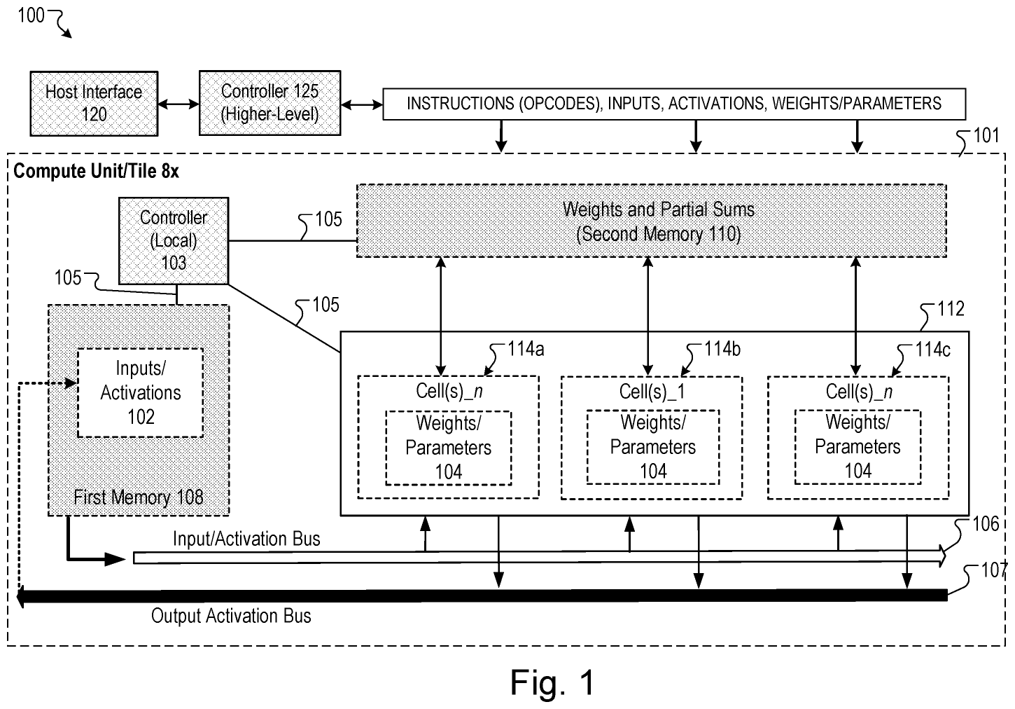

FIG. 1 is a block diagram of an example computing system 100 for implementing a neural network model at hardware integrated circuit, such as a machine-learning hardware accelerator. Compute system 100 includes one or more compute tiles 101, a host 120, and a higher-level controller 125 (“controller 125”). As described in more detail below, the host 120 and controller 125 cooperate to provide datasets and instructions to one or more compute tiles 101 of system 100.

In some implementations, the host 120 and the controller 125 are the same device. The host 120 and the controller 125 can also perform distinct functions but be integrated in a single device package. For example, the host 120 and controller 125 can form a central processing unit (CPU) that interacts or cooperates with a hardware accelerator, which includes the multiple compute tiles 101. In some implementations, the host 120, controller 125, and multiple compute tiles 101 are included or formed on a single integrated circuit die. For example, the host 120, controller 125, and multiple compute tiles 101 can form a special-purpose System-on-Chip (SoC) that is optimized for executing neural network models for processing machine-learning workloads.

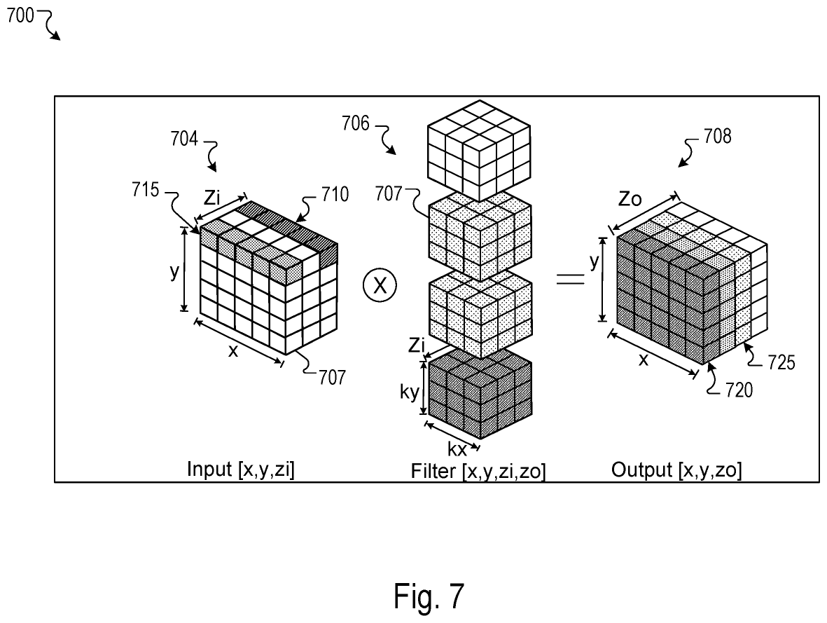

Each compute tile 101 generally includes a controller 103 that provides one or more control signals 105 to cause inputs (or activations) for an input vector 102 to be stored at, or accessed from, a memory location of a first memory 108 (“memory 108”). Likewise, the controller 103 can also provide one or more control signals 105 to cause weights (or parameters) for a matrix structure of weights 104 to be stored at, or accessed from, a memory location of a second memory 110 (“memory 110”). In some implementations, the input vector 102 is obtained from an input tensor, whereas the matrix structure of weights 103 is obtained from a parameter tensor. Each of the input tensor and the parameter tensor may be multi-dimensional data structures, such as a multi-dimensional matrix or tensor. This is described in more detail below with reference to FIG. 7.

Each memory location of memory 108, 110 may be identified by a corresponding memory address. Each of memory 108, 110 can be implemented as a series of banks, units, or any other related storage medium or device. Each of memory 108, 110 can include one or more registers, buffers, or both. In general, controller 103 arbitrates access to each of memory 108, 110. In some implementations, inputs or activations are stored at memory 108, memory 110, or both; and weights are stored at memory 110, memory 108, or both. For example, inputs and weights may be transferred between memory 108 and memory 110 to facilitate certain neural network computations.

Each compute tile 101 also includes an input activation bus 106, an output activation bus 107, and a computational unit 112 that includes multiply accumulate cells (MACs) 114 a/b/c. Controller 103 can generate control signals 105 to obtain operands stored at the memory of the compute tile 101. For example, controller 103 can generate control signals 105 to obtain: i) an example input vector 102 stored at memory 108 and ii) weights 104 stored at memory 110. Each input obtained from memory 108 is provided to input activation bus 106 for routing (e.g., direct routing) to a compute cell 114 a/b/c in the computational unit 112. Similarly, each weight obtained from memory 110 is routed to a cell 114 a/b/c of the computational unit 104.

As described below, each cell 114 a/b/c performs computations that produce partial sums or accumulated values for generating outputs for a given neural network layer. An activation function may be applied to a set of outputs to generate a set of output activations for the neural network layer. In some implementations, the outputs or output activations are routed for storage and/or transfer via output activation bus 107. For example, a set of output activations can be transferred from a first compute tile 101 to a second, different compute tile 101 for processing at the second compute tile 101 as input activations for a different layer of the neural network.

In general, each compute tile 101 and system 100 can include additional hardware structures to perform computations associated with multi-dimensional data structures such as tensors, matrices and/or data arrays. In some implementations, inputs for an input vector (or tensor) 102 and weights 104 for a parameter tensor can be pre-loaded into memory 108, 110 of the compute tile 101. The inputs and weights are received as sets of data values that arrive at a particular compute tile 101 from a host 120 (e.g., an external host), via a host interface, or from a higher-level control such as controller 125.

Each of compute tile 101 and controller 103 can include one or more processors, processing devices, and various types of memory. In some implementations, processors of compute tile 101 and controller 103 include one or more devices such as microprocessors or central processing units (CPUs), graphics processing units (GPUs), application specific integrated circuits (ASICs), or a combination of different processors. Each of compute tile 101 and controller 103 can also include other computing and storage resources, such as buffers, registers, control circuitry, etc. These resources cooperate to provide additional processing options for performing one or more of the determinations and calculations described in this specification.

In some implementations, processing unit(s) of controller 103 executes programmed instructions stored in memory to cause controller 103 and compute tile 101 to perform one or more functions described in this specification. The memory of controller 103 can include one or more non-transitory machine-readable storage mediums. The non-transitory machine-readable storage medium can include solid-state memory, a random access memory (RAM), a read-only memory (ROM), an erasable programmable read-only memory (e.g., EPROM, EEPROM, or Flash memory), or any other tangible medium capable of storing information or instructions.

The system 100 receives instructions that define a particular compute operation to be performed by a compute tile 101. In some implementations, a host can generate sets of compressed parameters (CSP) and corresponding mapping vectors, e.g., a non-zero map (NZM), for a given operation. For example, the host 120 can send, via a host interface, the compressed parameters to a compute tile 101 for further processing at the tile. The controller 103 can execute programmed instructions to analyze a data stream associated with the received weights and inputs, including the compressed parameters and corresponding mapping vectors.

The controller 103 causes inputs and weights of the data stream to be stored at the compute tile 101. For example, the controller 103 can store the mapping vectors and compressed sparse parameters in memory of the compute tile 101. This is described in more detail below. The controller 102 can also analyze the input data stream to detect an operation code (“opcode”). Based on the opcode, the controller 102 can activate special-purpose data path logic associated with one or more compute cells 114 a/b/c to perform sparse computations using the compressed sparse parameters and corresponding mapping vectors. As used in this document, sparse computations include neural network computations performed for a neural network layer using non-zero weight values in a set of compressed sparse parameters that are generated from a set of weights for the neural network layer.

In some implementations, the opcode indicates sparsity of one or more parameter tensors based on the values for K and N (described below). The controller 103 detects the opcode, including any related tensor sparsity information, uses local read logic to obtain the compressed parameters from tile memory based on the opcode, and wires or routes those compressed parameters to MACs 114 a/b/c of the compute tile 101.

As described in detail below, the controller 103 can also analyze an example data stream and, based on that analysis, generate a set of compressed sparse parameters and a corresponding mapping vector that maps discrete inputs of an input vector to the compressed sparse parameters. To the extent operations and/or processes for generating the compressed sparse parameters and corresponding mapping vectors are described with reference to controller 103, each of those operations and processes can be also performed by host 120, controller 125, or both.

In some implementations, performing some (or all) of the operations at the host 120, such as analyzing tensors indices, performing direct memory access (DMA) operations to read address spaces in system memory (e.g., DRAM) to obtain inputs and weight values, generating the compressed sparse parameters, and generating corresponding mapping vectors, will allow for reductions in processing time at each compute tile 101 and for improving data throughput at the system 100. For example, performing these operations at the host 120 using controller 125 allows for sending an already compressed set of parameters to a given tile compute 101, which reduces the size and quantity of data that is required to be routed at system 100.

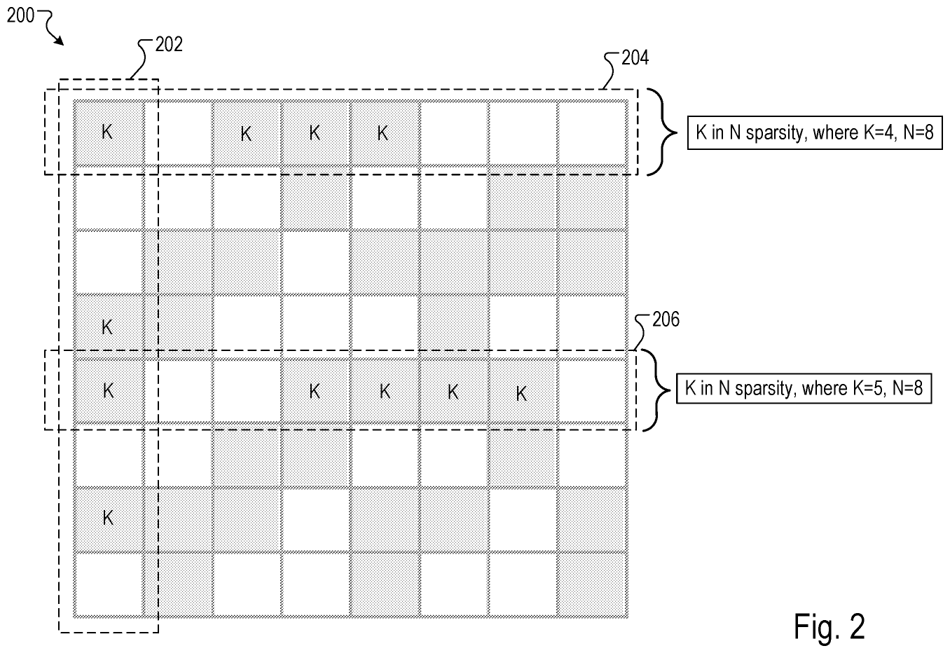

FIG. 2 shows an example parameter tensor 200 with K in N sparsity, which can represent a uniform sparsity format exhibited by sparse tensors. In general, for K in N sparsity, for every next N elements along a dimension (e.g., an innermost dimension) of a tensor, K elements are non-zero.

One or more opcodes can indicate or specify a sparsity attribute of one or more parameter tensors, as well as sparsity along a particular column (or row) dimension of a given tensor. For example, an opcode in a single instruction received at a compute tile 101 can specify a K in N sparsity of a parameter tensor 200, including K in N sparsity of each column 202 or row 204 of the parameter tensor 200. In some implementations, the tensor sparsity information specified by an opcode is based on a structure or configuration of an instruction set used at system 100.

In the example of FIG. 2, K indicates one or more non-zero values and N is a number of elements for a given parameter tensor 200. In some examples, N is the number of elements for a given row or column of a parameter tensor. Each of K and N are integers. N can be greater than or equal to one, whereas K can be greater than or equal to zero. The K in

N sparsity can be a ratio or some other numerical value that is assigned to, or conveyed as, a sparsity parameter.

The sparsity parameter characterizes a sparsity attribute or measure of sparsity in a dataset or tensor 200. For example, a sparsity parameter can represent a compression ratio for a given {K, N} pair and is equal to K/N, such that if K=2 and N=4, the compression ratio is 50%. The system 100 can support cases in which parameters are compressed in one (or more) dimension(s), such as along a column dimension corresponding to column 202. For this particular type of reduction operation, column 202 can be described as a reduction dimension or an inner product dimension. In some implementations, sparsity in a dataset is based on one or more patterns of sparsity that are detectable during a training phase of a neural network model, a deployment phase of the neural network model, or both.

The patterns of sparsity can be uniformly distributed among machine-learning datasets, such as parameter tensors 200 that are processed during the training and deployment phases of model execution. The uniformity of the sparsity patterns allow for a certain measure of predictability that can be exploited to realize efficiencies in acceleration of the neural network model. For example, and as explained below, patterns of sparsity that are uniformly distributed can allow for predicting, inferring, or otherwise detecting an upcoming pattern (e.g., a sparsity attribute) of zero or non-zero weight values. In some implementations, each of controller 103, 125 can be configured to learn, explore, and exploit different pattern options to realize additional efficiencies and optimizations in model execution.

In the example of FIG. 2, one or more opcodes received at the compute tile 101 can indicate that each of column 202 and row 204 includes a K in N sparsity of ½, where K=4, N=8. The controller 103 determines a value for a sparsity parameter based on the logical expression: % Sparsity=K−N. In this example the controller 103 can assign a value of ½ to a respective sparsity parameter for each of column 202 and 204. Relatedly, an opcode received at the compute tile 101 can also specify that row 206, which may also be a column, includes a K in N sparsity of ⅝, where K=5 and N=8. In some implementations, the K for a given K in N sparsity is determined based on a hardware layout of the compute tile 101. For example, the K can be determined based on a quantity of MAC circuits in a hardware compute cell of a computational unit 112 at a given compute tile 101.

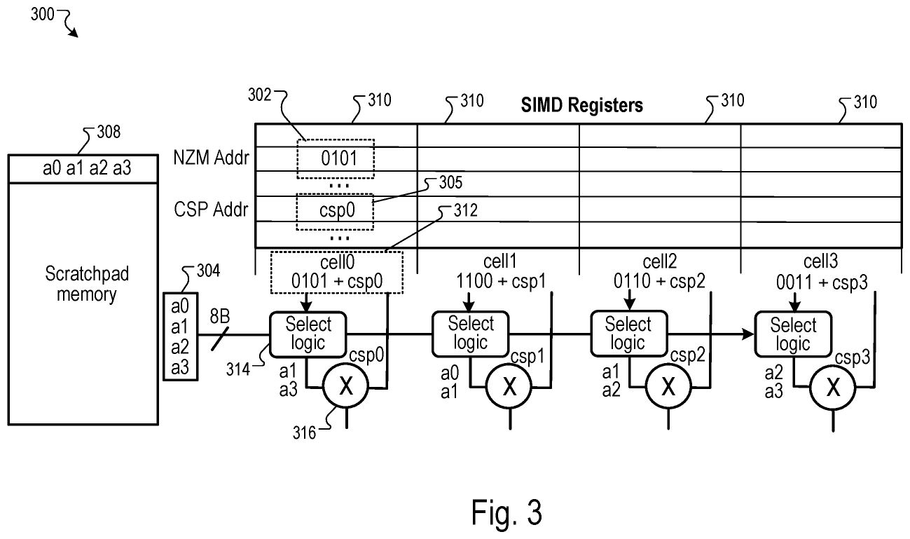

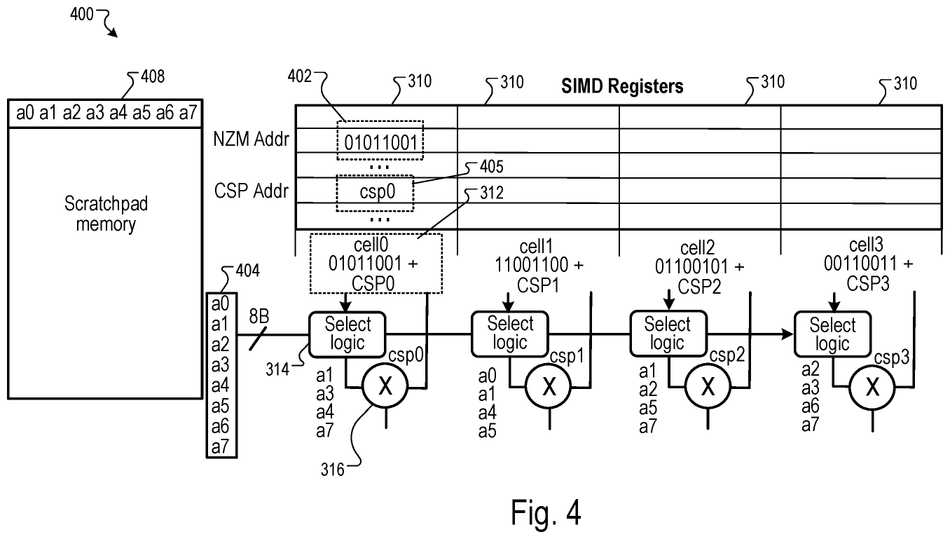

FIG. 3 shows a first example architecture 300 for processing a parameter tensor to generate compressed sparse parameters, whereas FIG. 4 shows a second example architecture 400 for processing a parameter tensor to generate compressed sparse parameters. Given the similarities between architecture 300 and 400, each of FIG. 3 and FIG. 4 are described concurrently by way of the following paragraphs.

The controller 103 processes the opcode and triggers one or more operations to exploit sparsity in a dataset for a machine-learning workload. The controller 103 can process the opcode to, for a given parameter tensor, identify or determine a respective measure of sparsity (e.g., sparsity parameter value) for the parameter tensor, such as for a row of the tensor, or for a column of the tensor. This operation can also involve analysis of the parameter tensor. In some implementations, the controller 103 triggers operations to exploit sparsity of a parameter tensor in response to determining a sparsity parameter value that represents a measure sparsity for a parameter tensor exceeds a threshold parameter value.

Based on the opcode, as well as any related sparsity threshold comparisons, the controller 103 triggers a determination of whether a weight value of a parameter tensor has a zero value or a non-zero value. For example, the controller 103 can analyze discrete weight values of a parameter tensor to detect a non-zero weight value. In response to detecting the non-zero weight value (e.g., which may be indicated as K), the controller 103 then uses that non-zero weight value to generate a set or grouping of compressed parameters.

In some implementations, the controller 103 extracts the detected non-zero weight value and uses the extracted weight to generate the set of compressed parameters. In some other implementations, rather than extract the weight value, the controller 103 associates the detected non-zero weight value with a set of compressed parameters, such as a set of compressed parameters previously generated by the host 120 and then passed to the controller 103 at the compute tile 101 by way of an example host interface. The controller 103 can also use a combination of extraction and association to generate a grouping of compressed parameters.

The controller 103 maps each detected non-zero weight value to a mapping vector 302, 402, which may be represented as a bitvector, bitmap, or other related data structure for indicating correlations or mappings between distinct data items. In some implementations, the controller 103 determines the mapping for the mapping vector with reference to a corresponding input vector 304, 404. For example, a mapping vector 302, 402 maps discrete inputs of an input vector 304, 404 to non-zero values of a set of compressed sparse parameters 305, 405, respectively.

In some implementations, the mapping vector is a non-zero bit map identified as parameter, NZM. An example CSP can correspond to a modified parameter tensor derived for an original, unmodified parameter tensor and the mapping is configured to preserve a respective dimensional position of each non-zero element in the original, unmodified parameter tensor prior to generating the modified parameter tensor. For example, the mapping vector can have the same dimensions as an original matrix for which the mapping vector is determined, but the mapping vector has 1-bit data type that is: i) set to “1” for a non-zero element (e.g., non-zero weight value) in that location in the original matrix or ii) set to “0” for a zero element (e.g., zero weight value) in that location in the original matrix.

The individual inputs of an input vector 304, 304 can be represented as {a0, a1, a2, a3, aN}, whereas individual weight values of a parameter tensor can be represented as {w0, w1, w2, w3, wN}. The mapping vectors 302, 402 use control values, such as binary values, to map individual inputs (e.g., a0, a1, a2, etc.) of an input vector 304, 404 to non-zero weights in a set of compressed sparse parameters 305, 405. The compute tile 101 includes selection logic 314 for selecting individual inputs of an input vector 304, 404 with reference to non-zero weights in a set of compressed sparse parameters 305, 405. The selection logic 314 references the mapping vectors to align its extraction of inputs in an input vector with corresponding non-zero weight values in a set of compressed sparse parameters.

In some implementations, the selection logic 314 is implemented in hardware, software, or both. For example, the controller 103 can access hardware selection logic 314 that is coupled to the first memory 108 and to the second memory 110 of a hardware accelerator. The controller 103 can use the selection logic 314 to select a particular input of the input vector and a corresponding weight value in the set of compressed sparse parameters based on a respective bit value of a bit in the mapping vector.

The controller 103 can generate a mapping vector that maps individual inputs of a multi-dimensional (3D) input tensor to non-zero weights in a multi-dimensional (3D) compressed sparse parameter tensor. In some implementations, for a given multi-dimensional tensor, a compute tile 101 is configured such that different cells, or groups of cells, in a compute unit 112 are assigned to operate on different columns or dimensions of a parameter tensor/weight matrix. Thus, a compute tile 101 can generate different bitmaps or mapping vectors for each cell or each grouping of cells. In this manner, each compute tile 101 can include respective selection logic that is uniquely configured for each cell, for each grouping of cells, or both.

The controller 103 generates control signals to store a set of compressed sparse parameters and a corresponding mapping vector in a memory location at the compute tile 101. For example, the memory 110 can include single instruction, multiple data (SIMD) registers that are each configured to store the mapping vector 302, 402 at a corresponding first address of an SIMD register 310 respectively. Likewise, the SIMD registers can also store the set of compressed sparse parameters 305, 405 at a corresponding second, different address of an SIMD register 310.

The SIMD registers 310 can include parallel cells that compute multiple dot products in parallel. The dot product computations may be performed in numerical formats or data types (dt) such as, INT8, BFLOAT, HALF, and INT16. In some implementations, data types for a computation are specified, or indicated, using one or more data fields of an opcode and/or instruction received at a compute tile 101.

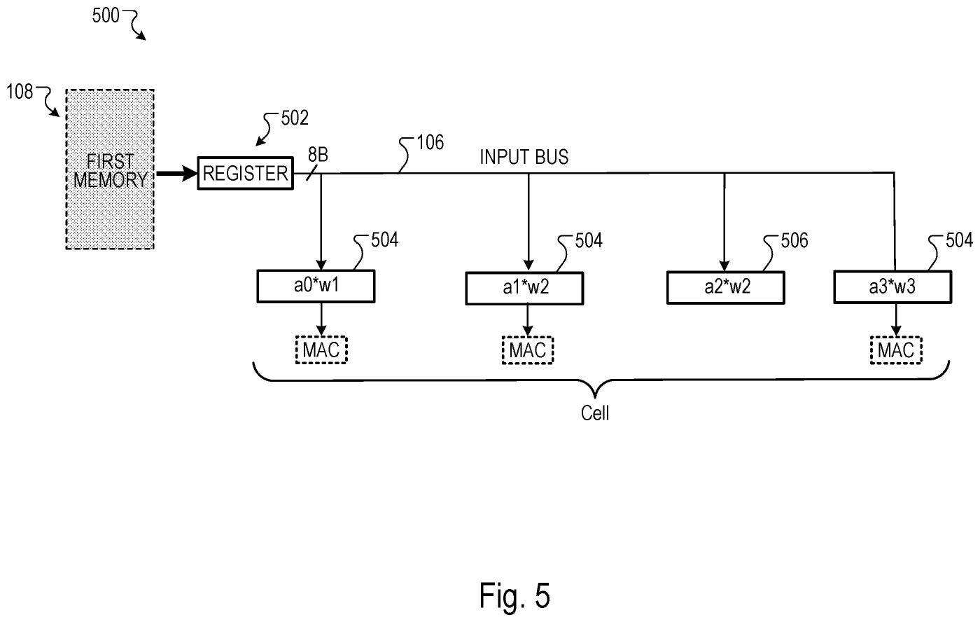

Each compute cell can use 4B for each operand, i.e., four INT8 elements for each operand, or two BFLOAT/HALF/INT16 elements for each operand. One operand is an input that is read from an example scratchpad memory (described below) and broadcast across the compute cells. The broadcast function is described below with reference to FIG. 5. The second operand is a weight value that is read from an SIMD register 310. In some implementations, the weight values are different for each cell.

As shown at Table 1 below, the techniques and architectures described in this specification can be used to accelerate computations for different combinations of K in N sparsity and data types (dt).

TABLE 1
Combinations of K in N sparsity and data types (dt)

| N | K | data type (dt) | Compression |
|---|---|---|---|
| N = 4 | K = 2 | dt = half/bfloat/int16 | Compression ratio = 50% |
| N = 8 | K = 4 | dt = int8 | Compression ratio = 50% |
| N = 8 | K = 2 | dt = half/bfloat/int16 | Compression ratio = 75% |
| N = 16 | K = 4 | dt = int8 | Compression ratio = 75% |
| N = 16 | K = 2 | dt = half/bfloat/int16 | Compression ratio = 87.5% |
| N = 32 | K = 4 | dt = int8 | Compression ratio = 87.5% |

Each cell can perform a multiply and accumulate function. The accumulate function is performed against partial sums generated from the multiply operations. The accumulate function can be expressed as: (MAC (operand1 (4B), operand4 (4B), partial_sum (32B)->partial_sum′ (32B)). In some implementations, each compute cell or MAC includes a cell accumulator and the partial sums are stored as partial results in the cell accumulator.

In the example of FIG. 3 and FIG. 4, the memory 108 can be implemented as a scratchpad memory 308, 408 respectively. In some implementations, one or more memory structures at a compute tile 101 can be implemented as a scratchpad memory, such as a shared scratchpad memory. The memory structures can be configured to support a direct memory access (DMA) mode which reduces incoming vector data into a memory location atomically, for example to support atomic floating-point reductions, instead of simply overwriting the data. In some implementations, resources of shared memory 308, 408 are configured to function as a software-controlled scratchpad rather than, for example, a hardware-managed cache.

In each of FIG. 3 and FIG. 4, a Boolean “0” corresponds to a detected zero weight value and a Boolean “1” corresponds to a detected non-zero weight value. In the example of FIG. 3, a mapping vector 302 is a 4-bit vector, whereas in the example of FIG. 4, a mapping vector 402 is an 8-bit vector. Each of mapping vectors 302, 402 can also have more or fewer bits. For example, each of mapping vectors 302, 402 can vary in size (or bits) based on design preference, processing constraints, system configuration, or a combination of these.

In some implementations, one or more of mapping vectors 302, 402 allow for streamlined processing of neural network operands of a machine-learning dataset at compute tile 101. To optimize the extent to the which neural network operations may be streamlined over conventional approaches, the system 100 leverages a particular hardware architecture of a special-purpose integrated circuit that uses a respective pairing of a broadcast input bus coupled to a grouping of compute cells across multiple compute tiles to accelerate execution of artificial neural networks. This is explained in detail below with reference to the example of FIG. 5.

FIG. 5 shows an example processing pipeline 500 for routing inputs obtained from a memory location of memory 108 to one or more compute cells 114. The pipeline 500 leverages a hardware architecture where the input bus 106 is coupled (e.g., directly coupled) to each of multiple groupings of hardware compute cells of special-purpose integrated circuit. The system 100 provides inputs or activations (e.g., a0, a1, a2, etc.) of an input feature map to a subset of MACs 114.

For example, a respective input of an input vector 102 is provided to each MAC in the subset via the input bus 106 of the compute tile 101. The system 100 can perform this broadcast operation across multiple compute tiles 101 to compute products for a given neural network layer using the respective groupings of inputs and corresponding weights at each compute tile 101. At a given compute tile 101, the products are computed by multiplying a respective input (e.g., a1) and corresponding weight (e.g., w1) at each MAC in the subset, using multiplication circuitry of the MAC.

The system 100 can generate an output for the layer based on an accumulation of multiple respective products that are computed at each MAC 114 in the subset. As explained below with reference to FIG. 7, the multiplication operations performed within a compute tile 101 can involve: i) a first operand (e.g., an input or activation) stored at a memory location of memory 108 that corresponds to a respective element of an input tensor and ii) a second operand (e.g., a weight) stored at a memory location of memory 110 that corresponds to a respective element of a parameter tensor.

In the example of FIG. 5, a shift register 502 can provide shift functionality in which an input of the operands 504 are broadcast onto the input bus 106 and routed to the one or more MACs 114. In some implementations, the shift register 502 enables one or more input broadcast modes at a compute tile 101. For example, the shift register 502 can be used to broadcast inputs sequentially (one-by-one) from memory 108, concurrently from memory 108, or using some combination of these broadcast modes. The shift register 502 can be an integrated function of memory 108, and may be implemented in hardware, software, or both.

As shown, in one implementation, the weight (w2) of the operands 506 may have a weight value of zero. When the controller 103 determines that the weight (w2) has a zero value, to conserve processing resources, a multiplication between an input (a2) and the weight (w2) can be skipped, such that those operands are not routed to, or consumed by, a cell 114 a/b/c. The determination to skip that particular multiplication operation can be based on a mapping vector that maps discrete inputs (an) of an input vector to individual weights (wn) of compressed sparse parameters, as described above.

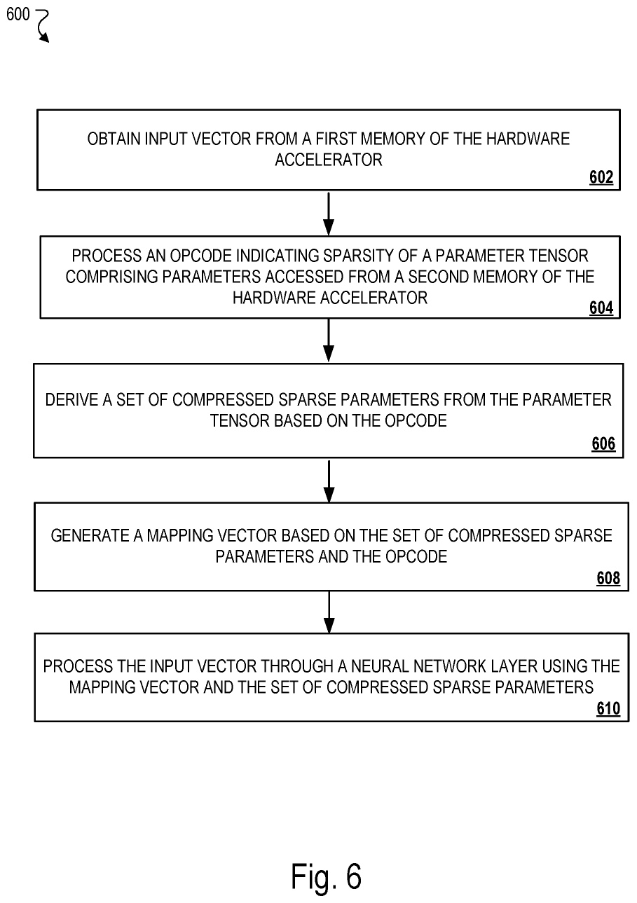

FIG. 6 is a flow diagram of an example process 600 for exploiting data sparsity during computations for a neural network implemented on a hardware accelerator. In some examples the computations are performed to process a neural network input, such as an image or speech utterance, using a special-purpose hardware integrated circuit.

For example, the hardware integrated circuit can be configured to implement a CNN that includes multiple neural network layers. In some cases, the neural network layers can include a group convolution layer. The input may be an example image as described above, including various other types of digital images or related graphical data. In at least one example, the integrated circuit implements a RNN for processing inputs derived from an utterance or other audio content. In some implementations, process 600 is part of a technique used to accelerate neural network computations that also allows for improved accuracy of image or speech processing outputs, relative to other data processing techniques.

Process 600 can be implemented or executed using the system 100 described above. Hence, descriptions of process 600 may reference the above-mentioned computing resources of system 100. In some examples, the steps or actions of process 600 are enabled by programmed firmware instructions, software instructions, or both; where each type of instruction is executable by one or more processors of the devices and resources described in this document.

In some implementations, the steps of process 600 are performed at a hardware circuit to generate a layer output for a neural network layer. The output can be a portion of computation for a machine-learning task or inference workload to generate an image processing or image recognition output. The integrated circuit can be a special-purpose neural net processor or hardware machine-learning accelerator configured to accelerate computations for generating various types of data processing outputs.

Referring again to process 600, an input vector is obtained from the first memory of a compute tile 101 of a hardware accelerator (602). For example, a controller 103 of the compute tile 101 generates control signals to obtain the input vector from address locations of the first memory 102. In some implementations, the input vector corresponds to an input feature map of an image and may be a matrix structure of neural network inputs, such as activations generated by a previous neural network layer.

The compute tile 101 processes an opcode that indicates sparsity among data used for the neural network computations (604). For example, the controller 103 can process the opcode in response to scanning, analyzing, or otherwise reading one or more instructions that are received at the compute tile. The opcode can indicate sparsity of an example parameter tensor that includes weights for one or more neural network layers. The parameter tensor and its corresponding weight (parameter) values are stored in, and accessed from, a memory of the hardware accelerator, such as the second memory 110. For example, the parameter tensor can be an 8×8 matrix with one or more columns or rows that have a K in N sparsity where K=2 and N=4 (i.e., 2 in 4 sparsity).

As explained below, the controller 103 reads the opcode and configures, at the compute tile 101, a computation for a neural network layer to exploit the sparsity indicated by the opcode. The opcode can be pre-determined by a compiler of an integrated circuit (e.g., the hardware accelerator) that generates an instruction set for execution at one or more compute tiles of the circuit. For example, the compiler is operable to generate an instruction set in response to compiling source code for executing neural network computations for a machine-learning workload, such as an inference or training workload. The instruction set can include a single instruction that is broadcast to one or more compute tiles 101.

A respective single instruction that is consumed by a given compute tile can specify an opcode that indicates sparsity of a parameter tensor assigned to that compute tile.

The opcode can also indicate operations to be performed at the compute tile 101 for exploiting the tensor sparsity. In some implementations, the opcode instructs the compute tile 101 to generate and execute localized instructions or control signals for exploiting tensor sparsity based on compressed sparse parameters and corresponding mapping vectors that are received at the compute tile, generated locally at the compute tile 101, or both.

In some implementations, the opcode is determined dynamically at run-time, e.g., by a higher-level controller 125 of the hardware accelerator or by a local controller 103 of a compute tile 101. The opcode may be a unique operation code included among multiple opcodes that are broadcast, by the higher-level controller, to multiple compute tiles of the hardware accelerator. As indicated above, in some implementations the multiple opcodes are broadcast in a single instruction that is provided to each of the multiple tiles 101 of the hardware accelerator.

A set of compressed sparse parameters derived from the parameter tensor obtained based on the opcode (606). The opcode in a single instruction received at a compute tile 101 can indicate 2 in 4 sparsity for a given column or row dimension of one or more parameter tensors. For example, the opcode can indicate that multiple columns 202 of parameter tensor 200 have a pattern (e.g., a sparsity pattern), where for every four elements along a given dimension, two of four elements are assigned zero value weights and two of the four elements are assigned non-zero value weights. The four elements can be {w0, w1, w2, w4}, where weights w1, w4 have non-zero weight values. Based on this, the controller 103 can detect these non-zero weight values and then access (or generate) a set of compressed sparse parameters represented as {w1, w4}.

A mapping vector is generated based on the set of compressed sparse parameters and the opcode (608). In some implementations, the mapping vector is generated external to the compute tile 101 and then provided to, and stored at, the compute tile 101. Based on a parameter tensor that includes the four elements {w0, w1, w2, w4} and the non-zero weight values of weights w1, w4, the controller 125 can then generate a mapping vector with reference to the input vector against which the weights of the four elements {w0, w1, w2, w4} are to be processed. The mapping vector can be based on an encoding scheme that indicates a location of zero and non-zero weight values of a corresponding parameter tensor. In some other implementations, controller 103 may perform operations to generate a mapping vector locally at a given compute tile 101.

The opcode can encompass one or more fields in an instruction (e.g., a single instruction) received at the compute tile 101. In some implementations, the opcode may include respective values for a first data item, K and a second, different data item, N. A compute tile 101 is operable to support various options for implementing sparse computations as indicated at least by the data values for K and N. For example, the compute tile 101 enumerates through those options based on data values of the opcode, including a value(s) for one or more fields of the opcode, in the instruction received at the compute tile 101.

For example, an opcode with data value N−8 and that specifies a datatype of int8(1B), e.g., for integer data, informs the controller 103 that a particular sparse computation requires reading or retrieving N*1B of activations from memory 108. Similarly, the opcode may instruct the controller 103 to perform a parameter read from the SIMD registers 310. For example, the controller 103 will retrieve N bits from the non-zero mapping vector (e.g., NZM) 302 and K*1B elements from the CSP 305 and activate the appropriate select logic to perform the sparse computation. Retrieving the required NZM bits and corresponding CSP elements for the parameter involves reading respective address spaces in the SIMD registers 310 that stores some (or all) of these data items.

An example operation may be described with reference to FIG. 3. From the perspective of a “cell0” in a computational unit 112 and considering arithmetic operations against an uncompressed tensor, the compute tile 101 is required to perform example dot product of: a0*w0 +a1*w1 +a2*w2 +a3*w3, where {a0, a1, a2, a3} is an example activation vector and {w0, w1, w2, w3} is an example weight vector corresponding to a sparse parameter tensor. The compute tile 101 analyzes each respective value of the weights in the weight vector and generates a mapping vector based on those values.

For example, the compute tile 101 can access, retrieve, or otherwise generate a

mapping vector corresponding to the weights {w0, w1, w2, w3} with a bitmap of [0101], where each bit of the bitmap corresponds to a respective value of a weight in the weight

vector. In this example, the bitmap indicates that each of weights w0 and w2 have a zero value. The compute tile 101 can also access, retrieve, or otherwise generate a compressed sparse parameter based on each respective value of the weights in the weight vector. For example, the controller 125 can derive a set of compressed parameters {w1, w3} from the weights {w0, w1, w2, w3}, which indicates that each of weights w1 and w3 have a non-zero value. Alternatively, or additionally, the compute tile 101 can also derive a set of compressed parameters locally based on operations performed by its local controller 103.

In some implementations, the compute tile 101 obtains or generates a compressed sparse parameter, CSP0, and associates the set of compressed parameters {w1, w3} with the compressed sparse parameter, CSP0. Each of the mapping vector and the CSP0 can be stored and later accessed from a respective address location of an SIMD register 310 of memory 110. For instance, the example mapping vector {0101} is stored at an NZM address of the SIMD register 310, whereas the parameter, CSP0, is stored at a CSP address of the SIMD register 310.

Using the mapping vector and the CSP0 {w1, w3}, the compute tile 101 can perform a dot product computation at cell0. For example, the compute tile 101 can perform the dot product computation al*w1 +a3*w3. In some implementations, to streamline this computation, the compute tile 101 can automatically initialize the multipliers in cell0 based on the non-zero weight values associated with parameter, CSP0. The compute tile 101 can then extract inputs a1 and a3 from the {a0, a1, a2, a3} activation vector based on the bitmap of the mapping vector. For example, the selection logic 314 of the compute tile 101 references the mapping vector to align its extraction of inputs a1 and a3 with the corresponding non-zero weight values of CSP0, {w1, w3}.

The input vector is processed through a layer of the neural network using the mapping vector and the set of compressed sparse parameters (610). In some implementations, the compute tile 101 performs dot product matrix multiplication operations to process the input vector through the layer of the neural network. The compute tile 101 performs a dot product matrix multiplication operation between inputs of the input vector and corresponding weight values in the set of compressed sparse parameters.

For example, the operations include multiplying an input or activation value with a weight value on one or more cycles to generate multiple products (e.g., partial sums), and then performing an accumulation of those products over many cycles. For each input, a dot product matrix multiplication operation may be performed at one or more multiplication cells of the hardware accelerator based on a respective bit value of each bit in the mapping vector

In some implementations, the compute tile 101, either alone or in cooperation with other compute tiles, performs convolution operations to process the input vector through the layer of the neural network. For example, the system 100 can perform a convolution at the neural network layer by processing inputs of an input feature map (e.g., an input vector) using compute cells of the hardware integrated circuit. The cells may be hardware multiply accumulate cells of a hardware computational unit at the hardware integrated circuit.

Additionally, processing the inputs also includes: providing weights of the compressed sparse parameters to a subset of the multiply accumulate cells of the hardware accelerator. In some implementations, the controller 103 determines a mapping of inputs of an input vector to cells of the compute tile based on one or more opcodes in an instruction (e.g., a single instruction) received at the compute tile 101. The controller 103 generates control signals 105 to provide the weights of the compressed sparse parameters to the subset of multiply accumulate cells based on the determined mapping. As explained above, the weights of the compressed sparse parameters are provided from an example SIMD register.

When performing a neural network computation for N=4, K=2,dt=half/bfloat/int16 (2 bytes), the compute tile 101 can be configured to: i) read four bits of a mapping vector, e.g., {0101}, stored at an NZM address and two compressed parameters (4B), e.g., {w1, w3}, stored at a CSP address; ii) read four elements (8B) of an activation operand from the scratchpad memory 308; iii) use four bits of the mapping vector, e.g., {0101}, to select the correct two compressed parameters (4B), e.g., {w1, w3} as the corresponding weight operands; iv) feed the appropriate activation operand and corresponding weight operand to a compute cell to perform a multiply accumulate operation; and v) increment the relevant addresses in memory to read the next activation operand and weight operand from memory.

When performing a neural network computation for N=8, K=4, dt=int, the compute tile 101 can be configured to: i) read eight bits of a mapping vector, e.g., {01011001}, stored at an NZM address and four compressed parameters (4B), e.g., {w1, w3, w11, w7}, stored at a CSP address; ii) read eight elements (8B) of an activation operand from the scratchpad memory 408; iii) use eight bits of the mapping vector, e.g., {01011001}, to select the correct four compressed parameters (4B), e.g., {w1, w3, w11, w7} as the corresponding weight operands; iv) feed the appropriate four operands (activations and corresponding weights) to a compute cell to perform multiply accumulate operations; and v) increment the relevant addresses in memory to read the next activation and weight operands from memory.

When performing a neural network computation for N=8, K=2,dt=half/bfloat/int16, the compute tile 101 can be configured to: i) read eight bits of a mapping vector, e.g., {01000001}, stored at an NZM address and two compressed parameters (4B), e.g., {w1, w3}, stored at a CSP address; ii) read eight elements (16B) of an activation operand from the scratchpad memory 408; iii) use eight bits of the mapping vector, e.g., {01000001}, to select the correct two compressed parameters (4B), e.g., {w1, w3} as the corresponding weight operands; iv) feed the appropriate two operands (activations and corresponding weights) to a compute cell to perform multiply accumulate operations; and v) increment the relevant addresses in memory to read the next activation and weight operands from memory.

When performing a neural network computation for N=16, K=4, dt=int, the compute tile 101 can be configured to: i) read 16 bits of a mapping vector, e.g., {01000001 00001100}, stored at an NZM address and four compressed parameters (4B), e.g., {w1, w3}, stored at a CSP address; ii) read 16 elements (32B) of an activation operand from the scratchpad memory 408; iii) use 16 bits of the mapping vector, e.g., {01000001 00001100}, to select the correct four compressed parameters (4B), e.g., {w1, w3, w11, w7} as the corresponding weight operands; iv) feed the appropriate four operands (activations and corresponding weights) to a compute cell to perform multiply accumulate operations; and v) increment the relevant addresses in memory to read the next activation and weight operands from memory.

When performing a neural network computation for N=16, K=2,dt=half/bfloat/int16, the compute tile 101 can be configured to: i) read 16 bits of a mapping vector, e.g., {01000000 00000100}, stored at an NZM address and two compressed parameters (4B), e.g., {w1, w3}, stored at a CSP address; ii) read 16 elements (32B) of an activation operand from the scratchpad memory 408; iii) use 16 bits of the mapping vector, e.g., {01000001 00001100}, to select the correct two compressed parameters (4B), e.g., {w1, w3} as the corresponding weight operands; iv) feed the appropriate two operands (activations and corresponding weights) to a compute cell to perform multiply accumulate operations; and v) increment the relevant addresses in memory to read the next activation and weight operands from memory.

When performing a neural network computation for N=32, K=4, dt-int, the compute tile 101 can be configured to: i) read 32 bits of a mapping vector stored at an NZM address and four compressed parameters (4B) stored at a CSP address; ii) read 32 elements (32B) of an activation operand from the scratchpad memory 408; iii) use 32 bits of the mapping vector to select the correct four compressed parameters (4B) as the corresponding weight operands; iv) feed the appropriate four operands (activations and corresponding weights) to a compute cell to perform multiply accumulate operations; and v) increment the relevant addresses in memory to read the next activation and weight operands from memory.

FIG. 7 illustrates examples of tensors or multi-dimensional matrices 700 that include an input tensor 704, variations of a parameter tensor 706, and an output tensor 708. In the example of FIG. 7, each of the tensors 700 include respective elements, where each element can correspond to a respective data value (or operand) for computations performed at a given layer of a neural network.

For example, each input of input tensor 704 can correspond to a respective element along a given dimension of input tensor 704, each weight of parameter tensor 706 can correspond to a respective element along a given dimension of the parameter tensor 706, and each output value or activation in a set of outputs can correspond to a respective element along a given dimension of output tensor 708. Relatedly, each element can correspond to a respective memory location or address in a memory of a compute tile 101 that is assigned to operate on one or more dimensions of a given tensor 704, 706, 708.

The computations performed at a given neural network layer can include multiplication of an input/activation tensor 704 with a parameter/weight tensor 706 on one or more processor clock cycles to produce layer outputs, which may include output activations. Multiplying an activation tensor 704 with a weight tensor 706 includes multiplying an activation from an element of tensor 704 with a weight from an element of tensor 706 to produce one or more partial sums. The example tensors 706 of FIG. 7 can be unmodified parameter tensors, modified parameter tensors, or combination of these. In some implementations, each parameter tensor 706 corresponds to a modified parameter tensor that includes non-zero CSP values that are derived based on the sparsity exploitation techniques described above.

The processor cores of system 100 can operate on: i) scalars that correspond to a discrete element in some multi-dimensional tensor 704, 706; ii) a vector of values (e.g., input vector 102) that include multiple discrete elements 707 along the same or different dimensions of some multi-dimensional tensor 704, 706; or iii) a combination of these. The discrete element 707, or each of the multiple discrete elements 707, in some multi-dimensional tensor can be represented using X,Y coordinates (2D) or using X,Y,Z coordinates (3D) depending on the dimensionality of the tensor.

The system 100 can compute multiple partial sums that correspond to products generated from multiplying a batch inputs with corresponding weight values. As noted above, the system 100 can perform an accumulation of products (e.g., partial sums) over many clock cycles. For example, the accumulation of products can be performed in a random access memory, shared memory, or scratchpad memory of one or more compute tiles based on the techniques described in this document. In some implementations, an input-weight multiplication may be written as a sum-of-product of each weight element multiplied with discrete inputs of an input vector 102, such as a row or slice of the input tensor 704. This row or slice can represent a given dimension, such as a first dimension 710 of the input tensor 704 or a second, different dimension 715 of the input tensor 704.

In some implementations, an example set of computations can be used to compute an output for a convolutional neural network layer. The computations for the CNN layer can involve performing a 2D spatial convolution between a 3D input tensor 704 and at least one 3D filter (weight tensor 706). For example, convolving one 3D filter 706 over the 3D input tensor 704 can produce a 2D spatial plane 720 or 725. The computations can involve computing sums of dot products for a particular dimension of an input volume that includes the input vector 102.

For example, the spatial plane 720 can include output values for sums of products computed from inputs along dimension 710, whereas the spatial plane 725 can include output values for sums of products computed from inputs along dimension 715. The computations to generate the sums of the products for the output values in each of spatial planes 720 and 725 can be performed: i) at the compute cells 114 a/b/c, ii) directly at the memory 110 using an arithmetic operator coupled to a shared bank of the memory 110, iii) or both. In some implementations, reduction operations may be streamlined and performed directly at a memory cell (or location) of memory 110 using various techniques for reduction of accumulated values.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method involving a neural network implemented on a hardware accelerator, the method comprising:
deriving, from a parameter tensor, a set of compressed sparse parameters;
generating a mapping vector based on the set of compressed sparse parameters;
processing an instruction indicating a sparse computation to be performed using the compressed sparse parameters based on a sparsity of the parameter tensor;
obtaining, based on the instruction, i) an input vector from a first memory of the hardware accelerator and ii) the compressed sparse parameters from a second memory of the hardware accelerator; and
performing the sparse computation to process the input vector through a layer of the neural network using the mapping vector and the set of compressed sparse parameters.

2. The method of claim 1, wherein processing the input vector through the layer of the neural network comprises:
performing a dot product matrix multiplication operation between inputs of the input vector and corresponding weight values in the set of compressed sparse parameters.

3. The method of claim 2, wherein the dot product matrix multiplication operation is performed at one or more multiplication cells of the hardware accelerator based on a respective bit value of each bit in the mapping vector.

4. The method of claim 2, further comprising:
accessing hardware selection logic coupled to the first memory and to the second memory of the hardware accelerator; and
selecting, using the hardware selection logic, a particular input of the input vector and a corresponding weight value in the set of compressed sparse parameters based on a respective bit value of a bit in the mapping vector.

5. The method of claim 1, wherein deriving the set of compressed sparse parameters comprises:
generating a modified parameter tensor comprising only non-zero elements along a particular dimension of the parameter tensor.

6. The method of claim 5, wherein generating the modified parameter tensor comprises:
for a particular column dimension of the parameter tensor:
generating a compressed representation of the column dimension based on non-zero elements of the column dimension; and
concatenating each non-zero element in the compressed representation of the column dimension.

7. The method of claim 6, wherein generating the modified parameter tensor comprises:
preserving a respective dimensional position of each non-zero element in the parameter tensor prior to generating the modified parameter tensor.

8. The method of claim 1, wherein:
the parameter tensor includes a plurality of dimensions; and
an opcode in the instruction indicates sparsity for a particular dimension of the plurality of dimensions.

9. The method of claim 1, wherein:
the hardware accelerator is operable to process a plurality of multi-dimensional parameter tensors; and
an opcode in the instruction indicates uniform sparsity across each of the plurality of multi-dimensional parameter tensors.

10. The method of claim 1, wherein the first memory is:
a scratchpad memory of the hardware accelerator; and
configured to store inputs and activations processed at the neural network layer.

11. The method of claim 10, wherein the second memory comprises a plurality of single instruction, multiple data (SIMD) registers and the method comprises:
storing the mapping vector at a first address of an SIMD register; and
storing the set of compressed sparse parameters at a second, different address of the SIMD register.

12. A system comprising:
a hardware accelerator configured to implement a neural network;
a processing device; and
a non-transitory machine-readable storage medium for storing instructions that are executable by the processing device to cause performance of operations comprising:
deriving, from a parameter tensor, a set of compressed sparse parameters;
generating a mapping vector based on the set of compressed sparse parameters;
processing an instruction indicating a sparse computation to be performed using the compressed sparse parameters based on a sparsity of the parameter tensor;
obtaining, based on the instruction, i) an input vector from a first memory of the hardware accelerator and ii) the compressed sparse parameters from a second memory of the hardware accelerator; and
performing the sparse computation to process the input vector through a layer of the neural network using the mapping vector and the set of compressed sparse parameters.

13. The system of claim 12, wherein processing the input vector through the layer of the neural network comprises:
performing a dot product matrix multiplication operation between inputs of the input vector and corresponding weight values in the set of compressed sparse parameters.

14. The system of claim 13, wherein the dot product matrix multiplication operation is performed at one or more multiplication cells of the hardware accelerator based on a respective bit value of each bit in the mapping vector.

15. The system of claim 13, wherein the operations further comprise:
accessing hardware selection logic coupled to the first memory and to the second memory of the hardware accelerator; and
selecting, using the hardware selection logic, a particular input of the input vector and a corresponding weight value in the set of compressed sparse parameters based on a respective bit value of a bit in the mapping vector.

16. The system of claim 12, wherein deriving the set of compressed sparse parameters comprises:
generating a modified parameter tensor comprising only non-zero elements along a particular dimension of the parameter tensor.

17. The system of claim 16, wherein generating the modified parameter tensor comprises:
for a particular column dimension of the parameter tensor:
generating a compressed representation of the column dimension based on non-zero elements of the column dimension; and
concatenating each non-zero element in the compressed representation of the column dimension.

18. The system of claim 17, wherein generating the modified parameter tensor comprises:
preserving a respective dimensional position of each non-zero element in the parameter tensor prior to generating the modified parameter tensor.

19. The system of claim 12, wherein:
the parameter tensor includes a plurality of dimensions; and
an opcode in the instruction indicates sparsity for a particular dimension of the plurality of dimensions.

20. The system of claim 12, wherein:
the hardware accelerator is operable to process a plurality of multi-dimensional parameter tensors; and
an opcode in the instruction indicates uniform sparsity across each of the plurality of multi-dimensional parameter tensors.

21. The system of claim 12, wherein the first memory is:
a scratchpad memory of the hardware accelerator; and
configured to store inputs and activations processed at the neural network layer.

22. The system of claim 21, wherein the second memory comprises a plurality of single instruction, multiple data (SIMD) registers and the operations further comprise:
storing the mapping vector at a first address of an SIMD register; and
storing the set of compressed sparse parameters at a second, different address of the SIMD register.

23. A non-transitory machine-readable storage medium for storing instructions that are executable by a processing device of a hardware accelerator configured to implement a neural network, wherein execution of the instructions causes performance of operations comprising:
deriving, from a parameter tensor, a set of compressed sparse parameters;
generating a mapping vector based on the set of compressed sparse parameters;
processing an instruction indicating a sparse computation to be performed using the compressed sparse parameters based on a sparsity of the parameter tensor;
obtaining, based on the instruction, i) an input vector from a first memory of the hardware accelerator and ii) the compressed sparse parameters from a second memory of the hardware accelerator; and
performing the sparse computation to process the input vector through a layer of the neural network using the mapping vector and the set of compressed sparse parameters.

24. A method performed using a hardware accelerator that implements a neural network comprising a plurality of neural network layers, the method comprising:
receiving an instruction for a compute tile of the hardware accelerator, the instruction being executable at the compute tile to cause performance of operations comprising:
identifying an opcode in the instruction that indicates sparsity of the parameter tensor;
loading a set of compressed sparse parameters based on weight values derived from a parameter tensor that specifies a plurality of weights for a layer of the neural network;
loading a mapping vector that is generated based on the set of compressed sparse parameters;
obtaining, based on the opcode, i) an input vector from a first memory of the hardware accelerator and ii) the set of compressed sparse parameters from a second memory of the hardware accelerator; and
processing, based on the mapping vector, the input vector through the layer of the neural network using the set of compressed sparse parameters.
